(19) United States
(12) Patent Application Publication
(10) Pub. No.: US 2013/0191258 A1
(43) Pub. Date: Jul. 25, 2013

(54) BILLING AND CREDIT FOR CONTENT IN A CROSS-PLATFORM SYSTEM

(71) Applicants: Fang Zhu, Woburn, MA (US); Zhiying Jin, Lexington, MA (US); Andre Turner, Belmont, MA (US)

(72) Inventors: Fang Zhu, Woburn, MA (US); Zhiying Jin, Lexington, MA (US); Andre Turner, Belmont, MA (US)

(73) Assignee: VERIZON PATENT AND LICENSING INC., Basking Ridge, NJ (US)

(21) Appl. No.: 13/358,170

(22) Filed: Jan. 25, 2012

(51) Int. Cl. G06Q 30/04

(52) U.S. Cl. 705/34

(57) ABSTRACT

A method includes identifying a subscription event for a digital service subscription for digital content. A billing cycle for the digital content is identified. The method includes determining whether an associated credit cycle for physical content is based on the identified billing cycle. The method also includes determining a billing action for the digital content based on the identified subscription event and the identified billing cycle. A credit action for physical content credits is determined based on the identified subscription event and the associated credit cycle in response to a determination that the associated credit cycle is based on the identified billing cycle. The method further includes determining a credit action for the physical content credits based on the identified subscription event and a maximum credit counter in response to a determination that the associated credit cycle is not based on the identified billing cycle.

### BACKGROUND

Multi-screen video architecture generally provides cross-platform access to a single content source. Among other benefits, multi-screen video provides consumers the possibility to watch video on a screen/device of their choice. For example, a live broadcast television event may also be available for viewing on various types of mobile devices.

### BRIEF DESCRIPTION OF THE DRAWINGS

FIG. 1 is an exemplary network in which systems and/or methods described herein may be implemented;

FIG. 2 is a block diagram of exemplary components of a device that may correspond to one of the devices of FIG. 1;

FIG. 3 is a block diagram of exemplary communications between components within a portion of the network of FIG. 1;

FIG. 4 is a diagram of exemplary functional components of the application server of FIG. 1;

FIG. 5 is a diagram of exemplary functional components of the catalog server of FIG. 1;

FIG. 6 is a diagram of exemplary functional components of the billing server of FIG. 1;

FIG. 7A is an exemplary functional block diagram of a portion of a network used to provide billing and credit for content in a cross-platform content system consistent with embodiments described herein;

FIG. 7B is an exemplary calendar month billing and credit table;

FIG. 7C is an exemplary activation date billing and credit table;

FIG. 7D is an exemplary maximum counter billing and credit table;

FIG. 8 is a flow chart of an exemplary process to provide billing and credit for content in a cross-platform content system according to an implementation described herein; and

FIG. 9 is a flow chart of an exemplary process for determining billing options in a cross-platform content system according to an implementation described herein.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

Systems and/or methods described herein may provide billing and credit for content in a cross-platform content system. The content may be provided as digital content on one platform and as physical content on another platform. The digital content may be provided as a digital service subscription associated with a digital content user account. The physical content may be provided as physical content credit to a physical content user account. Consistent with embodiments described herein, billing and credit may be provided for the content based on a calendar month cycle, or an activation date cycle. Credit may also be provided using a maximum counter for the physical content.

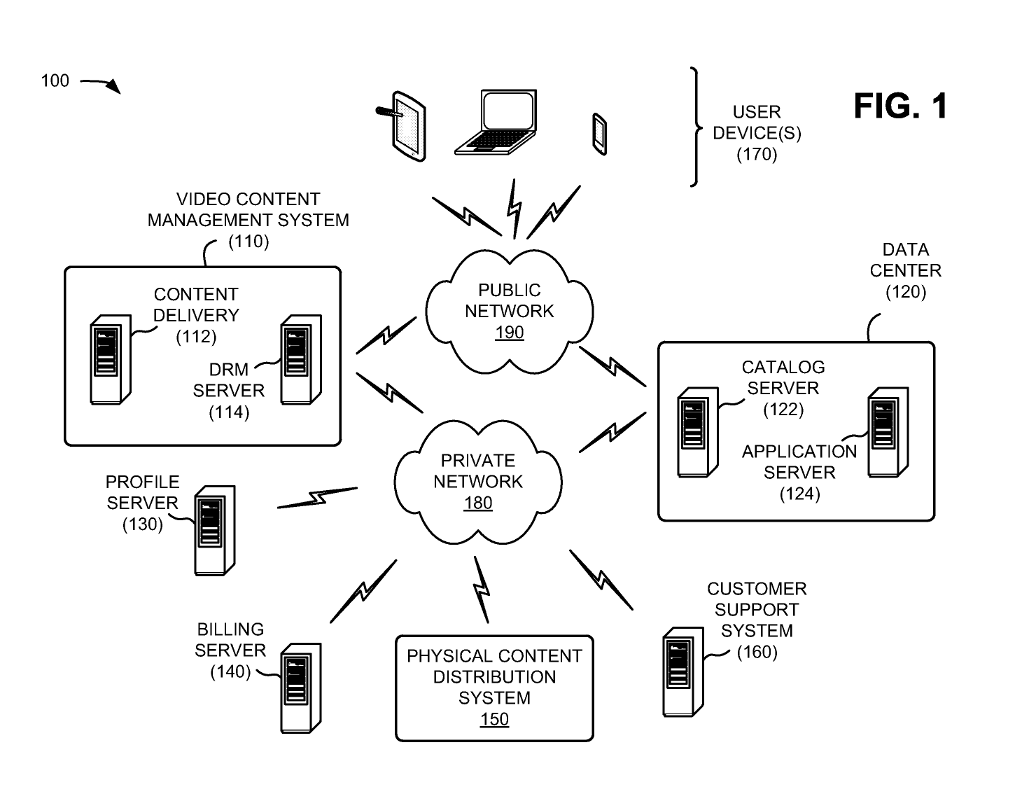

FIG. 1 is an exemplary network 100 in which systems and/or methods described herein may be implemented. As illustrated, network 100 may include a video content management system (VCMS) 110, a data center 120, a profile server 130, a billing server 140, a physical content distribution system 150, a customer support system 160, user devices 170, a private network 180, and a public network 190. The particular arrangement and number of components of network 100 shown in FIG. 1 are illustrated for simplicity. In practice there may be more VCMSs 110, data centers 120, profile servers 130, billing servers 140, physical content distribution systems 150, customer support systems 160, user devices 170, and/or networks 180/190. Components of network 100 may be connected via wired and/or wireless links.

VCMS 110 may aggregate content, process content, and distribute content. In one implementation, VCMS 110 may include a content delivery system 112 and a digital rights management (DRM) server 114. VCMS 110 may aggregate content and transcode content into a digital format suitable for consumption on particular user devices 110. For example, VCMS 110 may include a transcoding device to convert an audio, video, or graphic file from one format to another (e.g., from one bit rate to another bit rate, from one resolution to another, from one standard to another, from one file size to another, etc.). VCMS 110 may also encrypt data and communicate with DRM server 114 to enforce digital rights.

Content delivery system 112 may deliver digital content from a backend server to user devices 170. In one implementation, content delivery system 112 may include a streaming server that provides streaming data packets (e.g., via a streaming URL) to user devices 170 (e.g., via public network 190). In one implementation, a streaming URL may be session-based, such that each URL can be used only once for one user device 170 for security purposes.

DRM server 114 may issue, validate, and/or enforce DRM licenses to a device client, such as an application running on one of user devices 170. In implementations herein, DRM server 114 may communicate with user device 170 to authenticate a user of user device 170, the particular user device 170, and/or an application residing on user device 170. For example, DRM server 114 may request/receive login information associated with the user, and compare the login information with stored information to authenticate the user. Additionally, or alternatively, DRM server 114 may request/receive device information (e.g., a unique device identifier) associated with user device 170, and may compare the device information with stored information to authenticate user device 170.

Data center 120 may manage the authorization, selection, and/or purchase of multimedia content by a user of user devices 170. As shown in FIG. 1, data center 120 may include a catalog server 122 and an application server 124. In one implementation, data center 120 may be accessed by user devices 170 via public network 190.

Catalog server 122 may provide a unified catalog of content in both digital and physical formats for users (e.g., of user devices 170) to order/consume (e.g., buy, rent, or subscribe to). In one implementation, catalog server 122 may collect and/or present listings of content available to user devices 170. For example, catalog server 122 may receive digital and/or physical content metadata, such as lists or categories of content, from VCMS 110 and/or physical content distribution system 150. Catalog server 122 may use the content metadata to provide currently-available content options to user devices 170. Catalog server 122 may provide the content metadata to user device 170 directly or may communicate with user device 170 via application server 124.

Application server 124 may provide a backend support system for mobile applications residing on user devices 170. For example, application server 124 may permit user device 170 to download a video application that may permit a user to find content of interest or play downloaded or streaming content. The video application may enable user device 170 to present to a user of user device 170 information received from data center 120 in an interactive format to allow selection of particular digital or physical content. Application server 124 may provide content metadata, such as lists or categories of content for digital content, such as downloads and streaming content, and/or physical content, such as DVDs, Blu-ray discs, or memory cards. Application server 124 may provide the digital content in association with VCMS 110 and the physical content in association with physical content distribution system 150. Also, application server 124 may authenticate a user who desires to purchase, rent, or subscribe to digital or physical content. In one implementation, the interactions between application server 124 and user device 170 may be performed using the hypertext transfer protocol (HTTP) or the secure HTTP (HTTPS) via public network 190.

Profile server 130 may store user profile information for users (e.g., users of user devices 170). The user profile information may include various information regarding a user, such as login information (e.g., a user identifier and a password), billing information, address information, types of services to which the user has subscribed, a list of digital/physical content purchased by the user, a list of video content rented by the user, a list of video content to which the user has subscribed, a user device identifier (e.g., a media player identifier, a mobile device identifier, a set top box identifier, a personal computer identifier) for user device 170, a video application identifier associated with the video application obtained from application server 124, or the like. Application server 124 may use the user profile information from profile server 130 to authenticate a user and may update the user profile information based on the user's activity (e.g., with a user's express permission).

Billing server 140 may manage charging users for services provided via network 100. Billing server 140 may include, for example, a payment processing component, a billing component, and/or a settlement component.

Physical content distribution system 150 may track availability of physical content (e.g., DVDs, Blu-ray discs, memory cards, etc.) and provide metadata relating to the physical content for inclusion in catalog information provided to users of user devices 170. In one implementation, physical content distribution system 150 may also provide physical assets information, such as location information, so that when a user wants to buy a physical asset, the system can direct the user to the nearest location. Additionally, or alternatively, physical content distribution system 150 may generate or receive credit information for users (e.g., for cross-promotion purposes). For example, after a user of user device 170 has purchased a digital asset or subscription/rental, the user may be entitled some credits for getting physical asset or vice versa.

Customer support system 160 may solicit and/or receive user feedback, questions, or credit-related requests.

User device 170 may enable a user to view video content or interact with another user device 170 or a video display device (e.g., a set-top box and/or television). User device 170 may include, for example, a personal communications system (PCS) terminal (e.g., a smartphone that may combine a cellular radiotelephone with data processing and data communications capabilities), a tablet computer, a personal computer, a laptop computer, a gaming console, an Internet television, or other types of computation or communication devices. In one implementation, user device 170 may include a client-side application that enables user device 170 to communicate with, for example, data center 120 and/or present information received from data center 120 to a user. The client-side application may permit a user of user device 170 to log into an account (e.g., via application server 124), access catalog information (e.g., from catalog server 122), submit an order, and/or consume live streaming video content (e.g., from VCMS 110).

Private network 180 may include, for example, one or more private IP networks that use a private IP address space. Private network 180 may include a local area network (LAN), an intranet, a private wide area network (WAN), etc. In one implementation, private network 180 may implement one or more Virtual Private Networks (VPNs) for providing communication between, for example, any of VCMS 110, data center 120, profile server 130, billing server 140, physical content distribution system 150, and/or customer support system 160. Private network 180 may be protected/separated from other networks, such as public network 190, by a firewall. Although shown as a single element in FIG. 1, private network 180 may include a number of separate networks.

Public network 190 may include a local area network (LAN), a wide area network (WAN), such as a cellular network, a satellite network, a fiber optic network, a private WAN, or a combination of the Internet and a private WAN, etc. that is used to transport data. Although shown as a single element in FIG. 1, public network 190 may include a number of separate networks that function to provide services to user devices 170.

In implementations described herein, billing and credit may be provided for content in a cross-platform content system (e.g., network 100 described above). The content may include digital content and physical content that may be provided by different portions of network 100. Additionally, the billing and credit for the content may be provided based on a billing cycle, such as a calendar month cycle or an activation date cycle. Alternatively, credit may be provided based on a maximum counter that is substantially independent of the billing process.

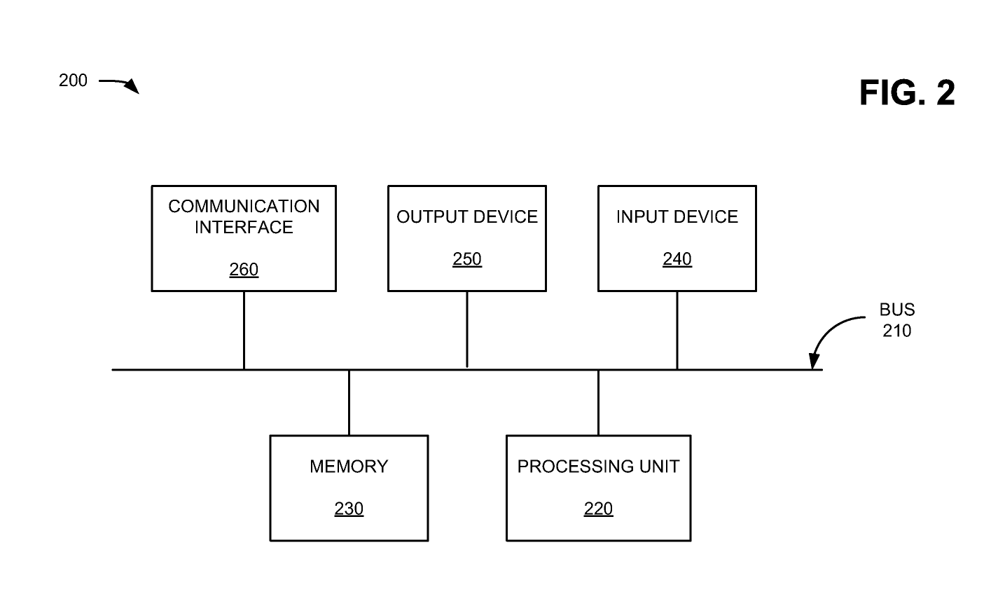

FIG. 2 is a diagram of exemplary components of a device 200 that may correspond to VCMS 110, content delivery system 112, DRM server 114, data center 120, catalog server 122, application server 124, profile server 130, billing server 140, physical content distribution system 150, customer support system 160, or user device 170. Each of VCMS 110, content delivery system 112, DRM server 114, data center 120, catalog server 122, application server 124, profile server 130, billing server 140, physical content distribution system 150, customer support system 160, and user device 170 may include one or more devices 200. As shown in FIG. 2, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. In other implementations, processing unit 220 may be implemented as or include one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits an operator to input information to device 200, such as a keyboard, a keypad, a mouse, a pen, a microphone, one or more biometric mechanisms, and the like. Output device 250 may include a device that outputs information to the operator, such as a display, a speaker, etc.

Communication interface 260 may include any transceiver-like mechanism that enables device 200 to communicate with other devices and/or systems. For example, communication interface 260 may include mechanisms for communicating with other devices, such as other devices of network 100.

As described herein, device 200 may perform certain operations in response to processing unit 220 executing software instructions contained in a computer-readable medium, such as memory 260. A computer-readable medium may include a non-transitory memory device. A memory device may include space within a single physical memory device or spread across multiple physical memory devices. The software instructions may be read into memory 260 from another computer-readable medium or from another device via communication interface 250. The software instructions contained in memory 260 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may include fewer components, different components, differently arranged components, or additional components than depicted in FIG. 2. As an example, in some implementations, input device 240 and/or output device 250 may not be implemented by device 200. In these situations, device 200 may be a “headless” device that does not explicitly include an input or an output device. Alternatively, or additionally, one or more components of device 200 may perform one or more other tasks described as being performed by one or more other components of device 200.

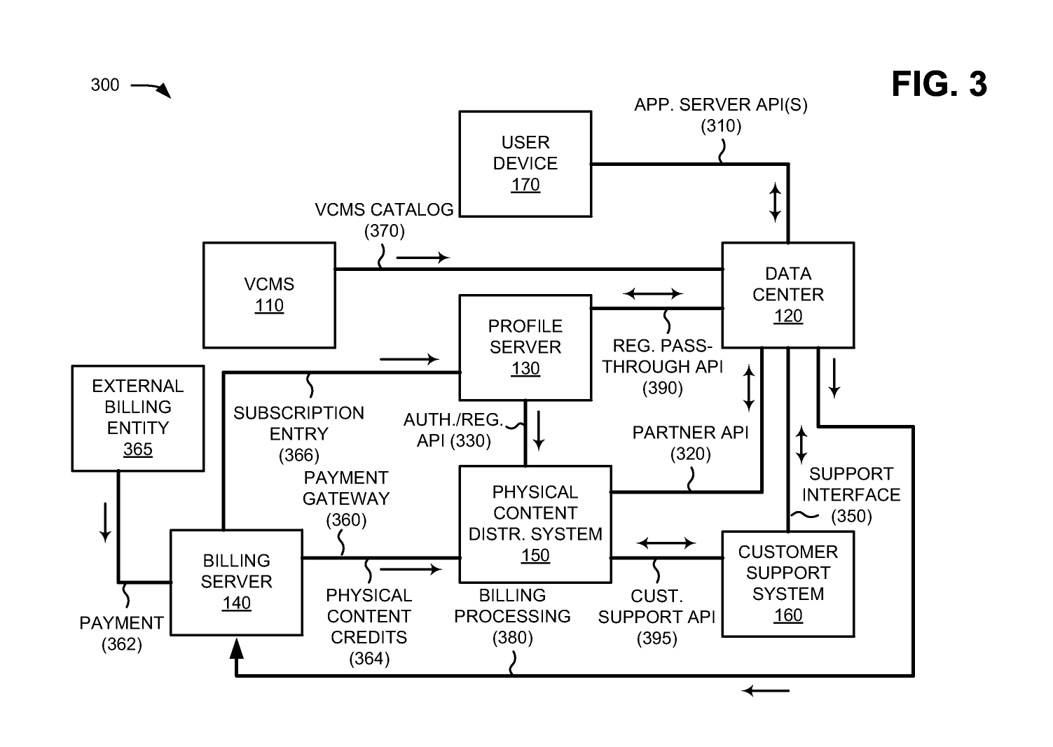

FIG. 3 is a diagram of exemplary communications for a portion 300 of network 100. Communications in FIG. 3 may represent communications to support billing and credit for content in a cross-platform content system. The cross-platform content system may provide content as digital content and physical content. As shown in FIG. 3, network portion 300 may include VCMS 110, data center 120, profile server 130, billing server 140, physical content distribution system 150, customer support system 160, user device 170, and external billing entity 365. VCMS 110, data center 120, profile server 130, billing server 140, physical content distribution system 150, customer support system 160, and user device 170 may include features described above in connection with, for example, FIGS. 1 and 2. Although arrows in portion 300 indicate direction of information flows that support a cross-platform billing process, it should be understood that communications within network portion 300 may be implemented in different manners than indicated by the arrows.

As shown in FIG. 3, user device 170 may request and data center 120 may provide an application server application program interface (API) 310. Data center 120 (e.g., application server 124) may provide different APIs to user device 170 depending, for example, on the type of operating system included on user device 170. For example, application server API 310 may include a web (e.g., web 2.0) API, an Andriod® API, an iOS API, or a Windows Phone® API. Other APIs may be provided for other applications, such as television-embedded applications, smart appliances, etc. API 310 provided by the application server in data center 120 may enable user device 170 to view and/or order content from catalogs provided via data center 120. The content may be delivered in a cross-platform format and may include digital content, which may be associated with one platform (e.g., a platform associated with a first provider, such as a digital content provider) and managed using VCMS 110, and physical content, which may be associated with another platform (e.g. a platform associated with a physical content provider) and managed using physical content distribution system 150.

Data center 120 may provide a partner API 320 to physical content distribution system 150. Partner API 320 may include, for example, an interface to identify/update physical asset locations, conduct authentication and registrations, and/or exchange credit information (e.g., for cross-promotion purposes).

Profile server 130 may provide an authentication and registration API 330 to physical content distribution system 150. Authentication and registration API 330 may permit profile server 130 to register new users with physical content distribution system 150 or to initiate user authentication procedures for physical content distribution system 150. In the case of new user registrations, profile server 130 may collect user information from user device 170 (e.g., via application server 124/data center 120) and provide the user information to physical content distribution system 150 to create an account in a physical content distribution system 150 database. In the case of authentications of existing user accounts, profile server 130 may collect user login information (e.g., a login name and password) from user device 170 (e.g., via application server 124) and provide the login information to physical content distribution system 150 for authentication. Assuming the user is authenticated by physical content distribution system 150, profile server 130 may generate a session token with a particular expiration time and send the session token to user device 170 (e.g., via application server 124) for future validation.

Physical content distribution system 150 may implement a catalog integration API (not shown) to inform VCMS 110 of physical assets available to users of user devices 170. Physical content distribution system 150 may use the catalog integration API to provide catalog descriptions for physical media assets and/or metadata about content on the physical assets, such as titles, formats (e.g., DVD, Blu-ray disc, memory card, etc.), and descriptions. In one implementation, the catalog integration API may support delivery of an XML metadata file to VCMS 110.

Customer support system 160 may provide a support interface 350 to data center 120. For example, support interface 350 may include APIs to enable communications with customer support system 160. For example, support interface 350 may provide an avenue to report customer disputes (e.g., originating from user devices 170) from data center 120 to customer support system 160.

Billing server 140 may process payment 362 for content provided by the cross-platform content system. Billing server 140 may provide a payment gateway 360 to physical content distribution system 150. Payment gateway 360 may provide a secure system to apply payments 362 (e.g., credit card payments) to a physical user account in physical content distribution system 150 for physical content ordered via data center 120. The physical user account may be a user account associated with a particular user in physical content distribution system 150.

Billing server 140 may receive payment 362 from external billing entity 365, such as a credit card payment system (e.g., for a credit card account associated with the user), a bank payment system (e.g., for a debit account associated with the user), etc., associated with the user and/or user device 170, via an external payment API (not shown). Additionally, or alternatively, billing server 140 may receive payment 362 via billing processing API 380 from data center 120, as described below. Billing server 140 may apply payment 362 to reconcile outstanding billing for services provided via the cross-platform system. For example, billing server 140 may receive payment 362 for a digital service subscription associated with a user account. Payment 362 may be provided in response to a periodic billing report, such as a monthly bill for the digital service subscription, provided to the user via a device, or account (e.g., email, online account), associated with the user.

The digital service subscription may include terms and conditions by which a content provider provides digital content on a periodic basis to a user. For example, the digital service subscription may be a monthly subscription that includes access to particular channels and or content. The digital service subscription may also include physical content credits 364 (e.g. cross-promotional credit for physical content distribution system 150) which may allow the user to select physical content from physical content distribution system 150. The physical content credits 364 may be provided periodically.

Billing server 140 may provide physical content credits 364 (e.g., physical content credits 364 associated with the digital service subscription), to the user's account in physical content distribution system 150 for physical content. Billing server 140 may also generate internal billing entries for digital content ordered by users and delivered via VCMS 110. Billing server 140 may also provide subscription entries 366 to profile server 130. Subscription entries 366 include changes to the digital service subscription, such as upgrades, downgrades, suspension, resumption, and cancellation of the digital service subscription. The upgrades and downgrades may include an associated upgrade or downgrade to physical content credits 364 provided in association with the digital service subscription.

VCMS 110 may include VCMS catalog API 370 to export or serve content metadata to data center 120. For example, VCMS 110 may combine information regarding available digital content (e.g., stored within VCMS 110) and catalog integration information received via catalog integration API 340 into a single unified catalog file. VCMS 110 may provide the unified catalog file to data center 120 using VCMS catalog API 370. VCMS 110 may also provide information identifying a provider and/or platform for each asset included in the unified catalog file. For example, VCMS 110 may provide identifiers in the unified catalog file for each asset that indicates an association of the asset with physical content distribution system 150, and/or an association with VCMS 110.

Data center 120 may provide billing processing information to billing server 140 via billing processing API 380. Billing processing information may include, for example, identification of and/or charges associated with content ordered by users of user devices 170. Billing processing API 380 may be used to support customer billing processes (e.g., for digital content) and fulfill payment transactions (e.g., for physical content).

Registration pass-through API 390 may provide a communication interface for data center 120 to exchange user registration and authentication information with profile server 130. Registration information may include, for example, user information (e.g., name, address, device identifiers, etc.) required to create an account for a user of user device 170. Authentication information may include, for example, information (e.g., a login name and password) to access a user's existing account. Data center 120 may pass registration/authentication information received from user device 170 to profile server 130, and profile server 130 may return validations to data center 120, via registration pass-through API 390.

Customer support API 395 may provide a communication interface to exchange information to resolve customer disputes. For example, customer support API 395 may enable customer support system 160 to submit dispute information to and retrieve account information from physical content distribution system 150.

Although FIG. 3 shows exemplary interfaces between components of network portion 300, in other implementations, network portion 300 may include fewer interfaces, different interfaces, differently arranged interfaces, or additional interfaces than depicted in FIG. 3. Alternatively, or additionally, one or more interfaces of network portion 300 may perform one or more other tasks described as being performed by one or more other interfaces of network portion 300.

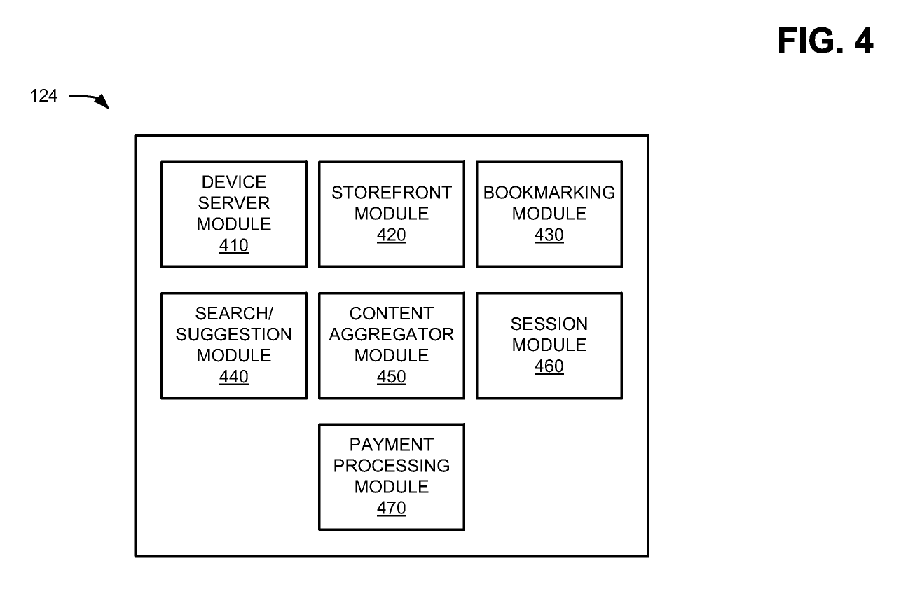

FIG. 4 is a diagram of exemplary functional components of application server 124. In one implementation, the functions described in connection with FIG. 4 may be performed by one or more components of device 200 (FIG. 2). As shown in FIG. 4, application server 124 may include a device server module 410, a storefront module 420, a bookmarking module 430, a search/suggestion module 440, a content aggregator module 450, a session module 460, and a payment processing module 470.

Device server module 410 supports interactions between user devices 170 and backend servers, including (but not limited to) catalog server 122, content delivery system 112, and DRM server 114. Device server module 410 may determine which content format to use according to the device type or platform. Device server module 410 may also aggregate content from different servers according to requests from user devices 170. In one implementation, device server module 410 may also temporarily cache some content locally for performance purposes.

Storefront module 420 provides a user interface to enable users to review and select content, including digital content and physical content, in a variety of formats. Storefront module 420 may support browsing and searching of the catalog (e.g., a unified catalog compiled by catalog server 122) from user devices 170. Storefront module 420 may also provide an electronic shopping cart, transaction management, and/or promotions and advertisements. Storefront module 420 may also support initial digital service subscription, including registration by the user with the content provider or service provider for the cross-platform content system.

Bookmarking module 430 tracks user viewing position (e.g., within particular digital content) and may allow users of user devices 170 to view the content beginning immediately subsequent to the most recently viewed position. In one implementation the most recently viewed position may be based on the viewing from the same user device 170. In another implementation the most recently viewed position may be based on the user account (e.g., regardless of the particular user device 170). For example, when a user starts to view a video, bookmarking module 430 may ask a user where to start the presentation, the beginning or where the bookmarking module 430 was stopped from last time (i.e., a last recorded user viewing position).

Search/suggestion module 440 provides a user interface to enable a user to search the catalog by keywords or review content suggestions or recommendations. Search/suggestion module 440 may recommend particular content to the user based on the user's search terms, profile, viewing history, or previously purchased content. Search/suggestion module 440 can also recommend physical assets based on the digital viewing history or personal preferences.

Search/suggestion module 440 may provide cross-platform popularity rankings for content to user devices 170. Search/suggestion module 440 may also provide digital ranking scores and physical ranking scores.

Content aggregator module 450 aggregates information from Internet searching and social networks related to particular content (e.g., a program or video) for a user to view and share. In one implementation, content aggregator module 450 may provide links or other menu options to enable a user to select related content provided by content aggregator module 450.

Session module 460 receives user login information and forwards the user login information to profile server 130 for validation. For example, session module may collect user login information from user device 170 and forward the login information to profile server 130. Assuming the user is authenticated (e.g., by profile server 130 or physical content distribution system 150), session module 460 may receive a session token and send the session token to user device 170.

Payment processing module 470 may include an interface with billing server 140 to bill the customer for the transaction of a purchase, a rental or a subscription. In one implementation, payment processing module 470 may also include a credit exchange interface with physical content distribution system 150. Alternatively, in another implementation, the credit exchange interface may be associated and/or collocated with billing server 140. In either implementation, when a user purchases digital content, coupon credits for obtaining physical media (e.g., DVDs or Blu-ray discs) may be deposited to a user account associated with physical content distribution system 150 via billing server 140.

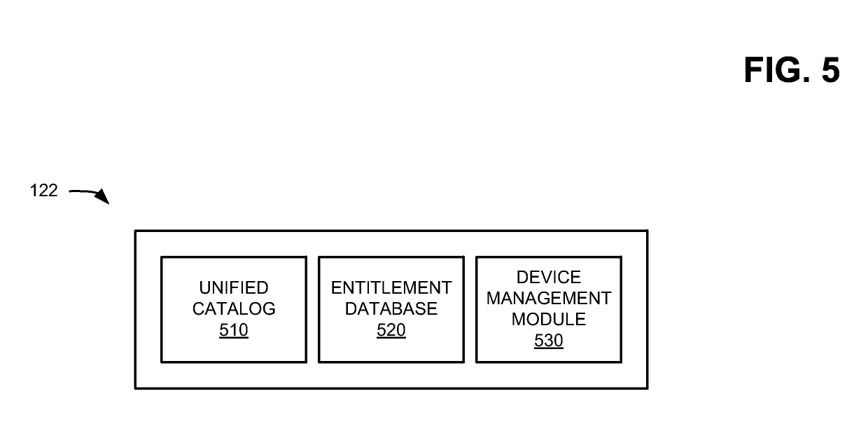

FIG. 5 is a diagram of exemplary functional components of catalog server 122. In one implementation, the functions described in connection with FIG. 5 may be performed by one or more components of device 200 (FIG. 2). As shown in FIG. 5, catalog server 122 may include a unified catalog 510, an entitlement database 520, and a device management module 530. Although unified catalog 510 is described with respect to catalog server 122, unified catalog 510 may be implemented in other parts of network 100. Additionally, catalog server 122 may be implemented to provide other types of catalogs in network 100. The particular arrangement and number of components in catalog server 122 as shown in FIG. 5 is illustrated for simplicity.

Unified catalog 510 includes a unified catalog of content available for all users to buy, rent or subscribe to, in a cross-platform content distribution system, such as shown in network 100 (FIG. 1). In one implementation, unified catalog 510 may be received from VCMS 110 and updated at periodic intervals.

Entitlement database 520 includes entitlement profiles for particular users. An entitlement profile may associate particular user devices 170 or platforms with particular types of content. Entitlement database 520 has entitlement rules associated with a user's profile and may indicate terms of usage associated with content, such as a right to transfer, a limited duration (i.e., rental) rights, etc. In one implementation, profiles in entitlement database 520 may be added/deleted/changed by a user via interactions with application server 124.

Device management module 530 associates unified catalog 510 with a user's entitlement profile in entitlement database 520 to enforce what content the user can view on which device. For example, if a user bought a particular movie, the user may be able to view the movie on only certain user devices 170 (e.g., a television, a personal computer, and/or or registered mobile devices). In one implementation, device management module 530 may verify entitlement before a DRM license can be issued to the user device 170.

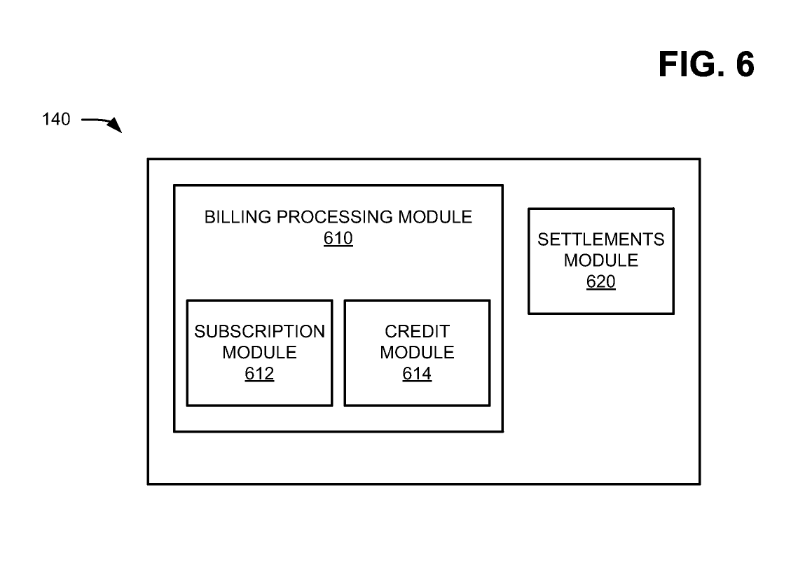

FIG. 6 is a diagram of exemplary functional components of billing server 140. In one implementation, the functions described in connection with FIG. 6 may be performed by one or more components of device 200 (FIG. 2). As shown in FIG. 6, billing server 140 may include a billing processing module 610 and a settlements module 620.

Billing processing module 610 performs processing to charge a digital content user account for a digital service subscription. The digital content user account may be an account associated with the user for digital content provided by a content provider or service provider via the digital platform in the cross-platform content system. Billing processing module 610 may charge the digital content user account after the user buys, rents, or subscribes to content listed in the video catalog. Billing processing module 610 may also apply credits associated with the digital content user account to a physical content user account for the user associated with physical content distribution system 150. The physical content user account may be an account associated with the user for physical content provided by a content provider or service provider via the physical platform in the cross-platform content system.

Billing processing module 610 may include a subscription module 612 and a credit module 614. Billing processing module 610 may receive (e.g., from payment processing module 470 in data center 120) a purchase or rental payment request and initiate a payment transaction via a payment gateway (e.g., credit card processing) to provide payment 362 for the digital service subscription.

Subscription module 612 may process payments 362 for digital service subscriptions, i.e., bills associated with subscription to particular digital content, and/or program packages, such as a combination of television channels, based on an associated billing cycle. For example, subscription module 612 may process payments 362 for digital service subscriptions automatically each month (or at another interval). Alternatively, subscription module 612 may issue a billing report to the user and process received payments 362 for bills associated with the digital content user account.

According to one implementation, subscription module 612 may bill the digital content user account, using an activation date billing cycle, e.g., each month, for the digital service subscription. The subscription module 612 may bill the digital content user account at an activation date, which may be a date in each month (e.g., every fourteenth day of each month) at which the user is billed. The activation date may correspond to a date of the month that the user initially received the digital service subscription, or an upgrade, or downgrade to the digital service subscription.

According to another implementation, subscription module 612 may bill the digital content account, using a calendar month billing cycle, for the digital service subscription. Subscription module 612 may bill the user account at a recurring date provided by a content provider in each calendar month. For example, subscription module 612 may bill the user account at the first (or alternatively the fifteenth) of each month. Subscription module 612 may apply the calendar month billing cycle to a plurality of users of the digital content platform. Subscription module 612 may provide subscription entries 366 to entitlement database 520 for the user in profile server 130 based on changes to the digital service subscription.

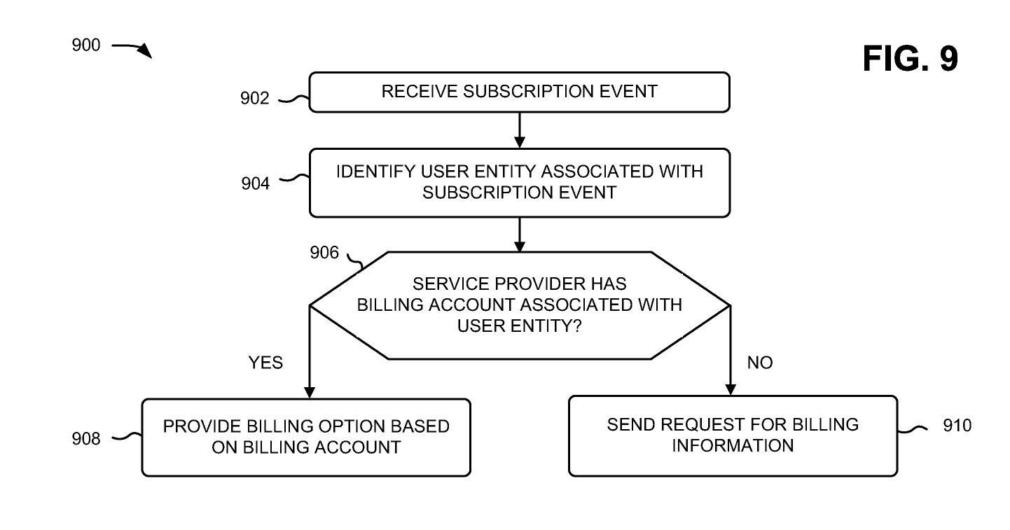

According to another implementation, subscription module 612 may provide additional billing options for the digital service subscription. For example, subscription module 612 may provide billing options based on an existing billing account associated with a user entity associated with the digital service subscription, such as described herein with respect to process 900 and FIG. 9.

Credit module 614 may assign physical content credits to the physical content user account in physical content distribution system 150. Credit module 614 may include a credit exchange interface with physical content distribution system 150 via which credit module 614 may provide physical content credits 364. Credit module 614 may assign physical content credits 364 based on an indication received from subscription module 612 based on the digital service subscription. The indication may define a number of physical content credits 364 to be provided to the physical content user account and a schedule and terms by which the physical content credits 364 are to be provided.

According to one implementation, credit module 614 may provide physical content credits 364 to the physical content user account in physical content distribution system 150 in a calendar month credit cycle (i.e., a credit provision cycle) based on a calendar month billing cycle for the digital service subscription. Credit module 614 may provide physical content credits 364 automatically based on a predetermined schedule received from subscription module 612, or may provide physical content credits 364 on receipt of an indication of the status of the digital service subscription from subscription module 612. Credit module 614 may provide physical content credits 364 on a prorated basis for the first month of subscription to a digital service in a calendar month billing cycle.

According to another implementation, credit module 614 may provide physical content credits 364 to the physical content user account in physical content distribution system 150 in an activation date credit cycle based on an activation date billing cycle for the digital service subscription. The activation date credit cycle may be based on a same activation date as the activation date billing cycle for the digital service subscription.

According to another implementation, credit module 614 may provide physical content credits 364 to the physical content user account in physical content distribution system 150 based on a maximum credit counter. Credit module 614 may provide the credits using a maximum credit counter on a credit cycle independent of the billing cycle for the digital service subscription. For example, the digital service subscription may be billed on an activation date billing cycle and the credit counter billing cycle may be billed on a calendar month billing cycle. According to one implementation, credit module 614 may provide physical content credits 364 at a different frequency than the billing cycle for the digital service subscription. For example, credit module 614 may provide physical content credits 364 on a quarterly (i.e., every three months) basis while the digital service subscription is billed at a monthly frequency.

According to another implementation, credit module 614 may provide a capability that allows the user or an internal user (e.g., a customer service operator for the service provider) to select between different types (e.g., DVDs or Blu-ray discs) of physical content credits 364 based on a type of billing cycle for the digital service subscription and a subscriber status associated with the user account. The subscriber status associated with the user account may be determined based on a length of time that the user has been receiving the service and may include an introductory status, a first year status, a longtime customer status, etc. The introductory status may be provided for user accounts and digital service subscriptions that have been established during a preceding time, e.g., a previous three months. Similarly, new customer status may be indicated for user accounts and digital service subscriptions that have been established for a time greater than the introductory time (i.e., after an introductory time has expired) but less than a time for a longtime customer.

Credit module 614 may provide physical content credits 364 as a default type of physical content credits 364 (e.g., DVD credits) and allow the user to change a type of physical content credits 364 (e.g., from DVD credits to Blu-ray disc credits) if the user account has an associated introductory status.

Billing processing module 610 may synchronize the billing results with profile server 130 (e.g., subscription entitlement module 730) to enforce entitlement restrictions and may generate a report (e.g., either periodically for a group or transactions or for individual transactions) related to physical assets. In one implementation, billing processing module 610 may also include an interface with customer support system 160 to permit credit adjustments and/or cancellations related to charge disputes.

Settlements module 620 includes features to provide cost assurance and revenue assurance. Cost assurance assures that partners (such as a studio or another content source) are paid according to a previously agreed contract. Contract information (e.g., for content sources) may be provided from a contract management source (not shown). Revenue assurance ensures that users have paid a bill according to the user's purchase, rental, or subscription agreement. In one implementation, settlements module 620 may receive a settlement file from VCMS 110 that identifies content provider settlements (e.g., how much revenue to share with particular studios) based on actual usage statistics. Settlements module 620 may also include an interface with individual content providers (not shown) to provide revenue accounting.

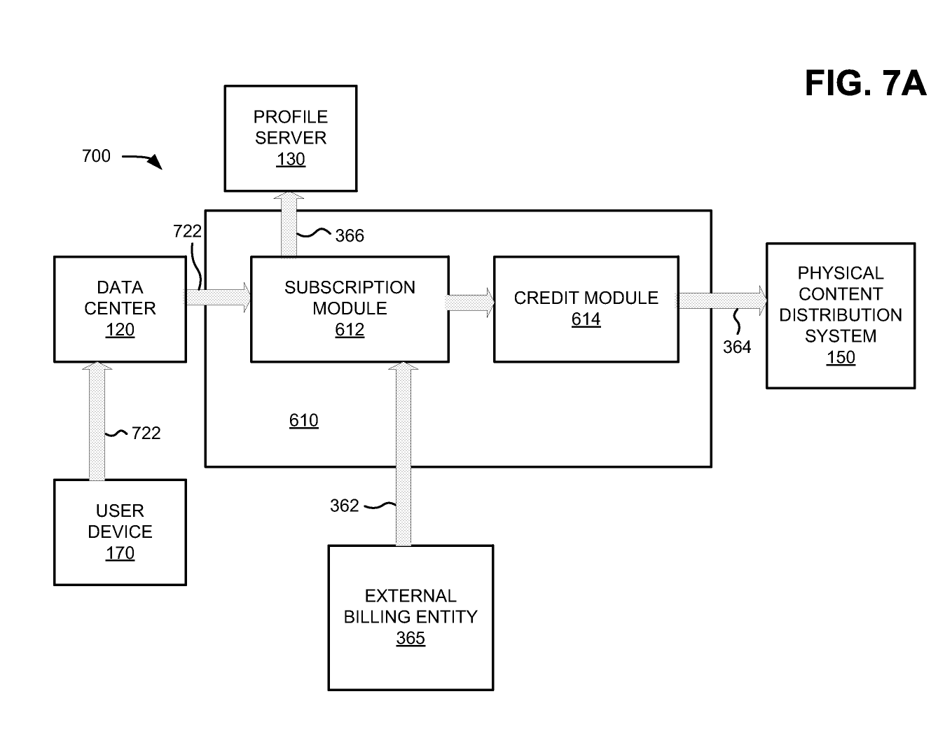

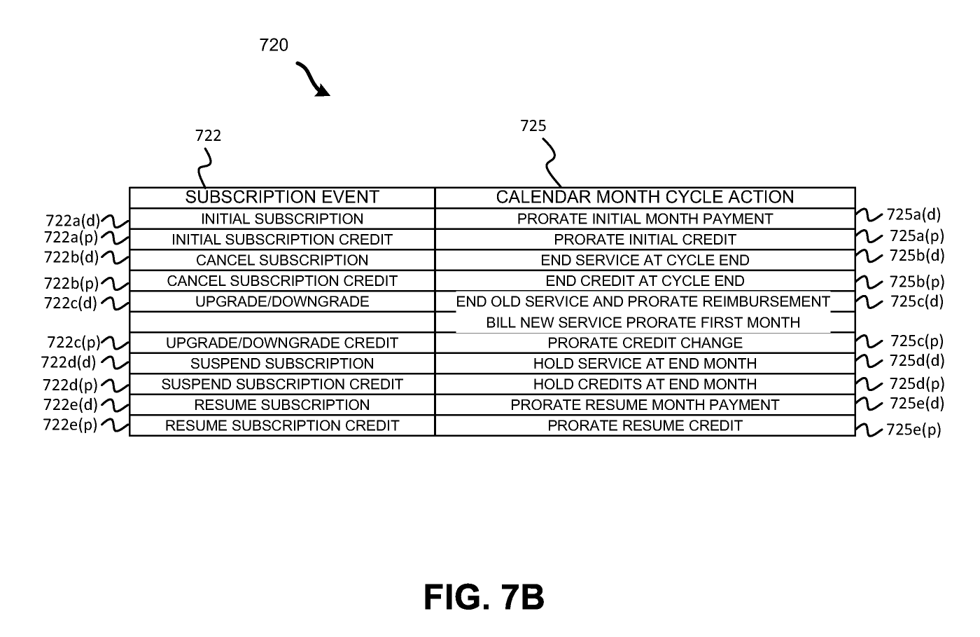

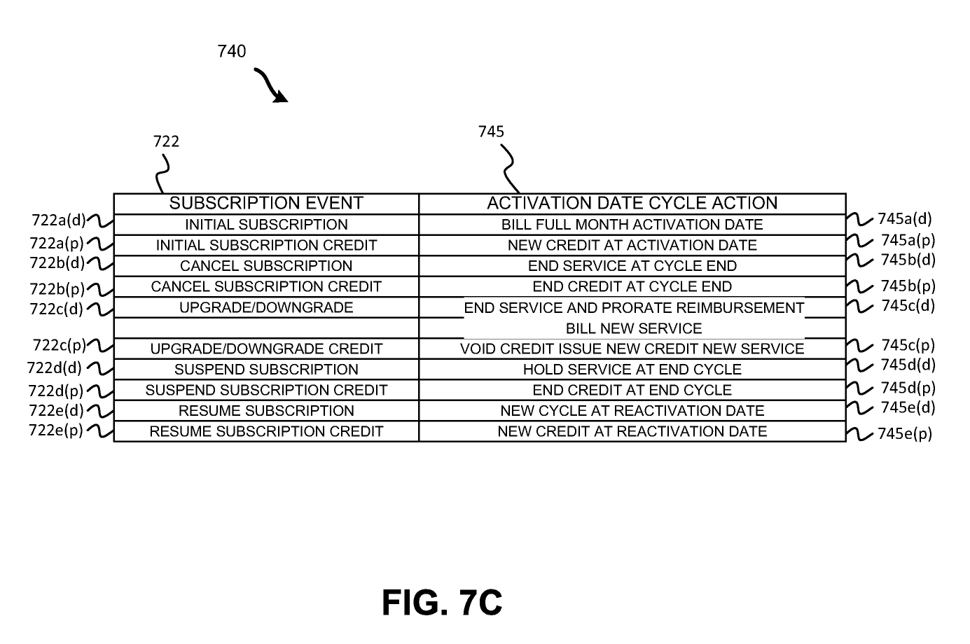

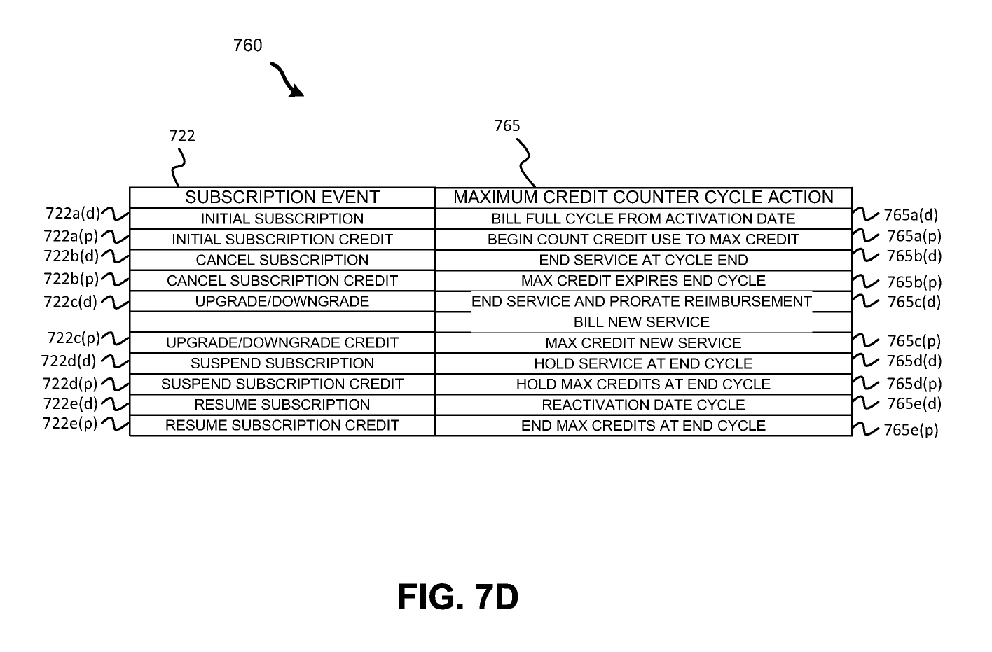

FIG. 7A is a billing and credit data flow diagram 700 for a portion of network 100. As shown in FIG. 7A, billing and credit data flow diagram 700 may include subscription module 612 and credit module 614 (i.e., a portion of billing server 140, such as described with respect to FIG. 6), data center 120, and physical content distribution system 150. The particular arrangement and number of components in data flow diagram 700 as shown in FIG. 7A is illustrated for simplicity. FIG. 7A is described with respect to FIGS. 7B, 7C, and 7D, which illustrate a calendar month billing and credit table 720, an activation date billing and credit table 740, and a maximum counter billing and credit table 760, respectively. Events 722 and actions 725, 745, 765 affecting digital content are denoted by a postscript (d) in tables 720, 740 and 760, while events 722 and actions 725, 745, 765 affecting physical content are denoted by a postscript (p) in tables 720, 740, and 760, respectively.

Calendar month billing and credit table 720, as shown in FIG. 7B, illustrates corresponding calendar month cycle actions 725 that subscription module 612 may perform in response to received subscription events 722. Similarly, activation date billing and credit table 740, as shown in FIG. 7C, illustrates corresponding activation date cycle actions 745 that subscription module 612 may perform in response to received subscription events 722. Maximum counter billing and credit table 760, as shown in FIG. 7D, illustrates corresponding maximum credit counter cycle actions 765 that subscription module 612 may perform in response to received subscription events 722. The same types of subscription events 722 are included in tables 720, 740, and 760 as shown in FIGS. 7B-7D.

As shown in FIG. 7A, subscription module 612 may receive a subscription event 722 and determine subscription entries 366 based on the received subscription event 722. Subscription event 722 may be an event that affects a subscription status of a user for a digital service subscription including entitlements to digital content, billing for the digital service subscription and a number of physical content credits 364 that the user may receive in cross-platform content system. Subscription entries 366 may include entitlements to digital content, billing rates, billing dates, etc., for the digital service subscription associated with a user account. Subscription module 612 may provide subscription entries 366 to profile server 130 based on each subscription event 722.

Subscription event 722 may be an initial subscription 722a(d) to the digital service subscription. Initial subscription 722a(d) may define a billing date and amount for payments 632 for the digital service subscription. Alternatively, subscription event 722 may be a cancellation (cancel subscription) 722b(d), upgrade or downgrade of a subscription (upgrade/downgrade) 722c(d) (i.e., a change to additional/different programs at a different billing rate), suspension (suspend subscription) 722d(d), or a resumption of a suspended subscription 722e(d), to a digital service subscription.

Subscription module 612 may receive a subscription event 722(d) from a user device 170 via data center 120. For example, the user may initially subscribe 722a(d) to the digital service subscription via user device 170. Alternatively, subscription module 612 may determine a subscription event 722(d). Subscription module 612 may receive payments 362 for digital service subscriptions from external billing entities 365 associated with each user. If a payment 362 is not received for a user by a billing date, subscription module 612 may suspend the subscription 722d(d) to the digital service subscription for the particular user.

The digital service subscription may be billed based on different billing cycles, such as a calendar month cycle or an activation date billing cycle. In the calendar month cycle, subscription module 612 may bill the user at a particular monthly date (e.g. the beginning of each month). In the digital service, subscription module 612 may bill the user account at the activation date of the digital service subscription for the user.

Subscription module 612 may provide an indication of a particular subscription event 722 to credit module 614. Credit module 614 may determine a number of physical content credits 364 associated with a digital service subscription that are to be provided to a physical user account for the user.

Subscription module 612 may determine billing actions 725(d), 745(d), 765(d) based on subscription events 722 and particular billing cycles as described with respect to FIGS. 7B, 7C and 7D, respectively. Credit module 614 may also determine credit actions 725(p), 745(p) based on subscription events 722 and particular billing cycles as described with respect to FIGS. 7B and 7C, respectively. Further, credit module 614 may determine credits actions 765(p) based on a maximum credit counter, as described with respect to FIG. 7D.

Calendar month cycle billing and credit table 720, shown in FIG. 7B, displays subscription events 722 and corresponding calendar month cycle billing and credit actions 725 that are determined based on a calendar month billing cycle. Subscription module 612 may determine billing actions 725(d) based on subscription events 722 and the calendar month cycle. Credit module 614 may determine credit actions 725(p) based on subscription events 722(p) and the calendar month cycle. The following implementations are described with respect billing and credit based on a calendar month billing cycle by subscription module 612 and credit module 614 respectively.

Subscription module 612 may receive initial subscription 722a(d) and determine that an initial payment (i.e., a billed payment for a first month of the digital service subscription) is to be prorated based on a date that the user initially subscribed for the digital service subscription and a start date of the calendar month billing cycle (e.g., the first day of each month based on a provider assigned billing date). For example, subscription module 612 may determine a prorated initial month payment for a user that subscribes to the digital service subscription on the fifteenth day of the month, in this instance a half of the monthly rate. Similarly, credit module 614 may receive initial subscription credit 722a(p) (i.e., a command to provide credits based on the initial subscription) and determine that an initial allocation of physical content credits 364 is to be prorated 725a(p) based on the date of the initial subscription and the calendar month billing cycle. For example, credit module 614 may provide half of the monthly allocation of physical content credits 364 to a physical user account. The allocation of physical content credits 364 may expire at the end of each calendar month.

In another implementation, subscription module 612 may identify that the digital service subscription is to be cancelled (cancel subscription) 722b(d). Subscription module 612 may determine that the digital service subscription is to be cancelled at the end of the calendar month cycle based on the cancel subscription 722b(d). Similarly, credit module 614 may receive cancel subscription credit 722b(p) and determine that the physical content credits 364 are to be cancelled 725b(p) at the end of the calendar month cycle.

In another implementation, subscription module 612 may receive an upgrade/downgrade 722c(d) of the digital service subscription. Subscription module 612 may determine that the current digital service subscription is to be cancelled at the date of the upgrade/downgrade 722c(d). Subscription module 612 may determine that the user is to be reimbursed on a prorated basis (i.e., receive a prorated reimbursement) for a remainder of the calendar month. Subscription module 612 may bill for the first month of the new digital service subscription on a prorated basis based on the date of the upgrade or the downgrade. Credit module 614 may provide a prorated allocation 725c(p) of the physical content credits based on the date of the upgrade or the downgrade. For example, if the physical content credits 364 provided in association with the new digital service subscription are twice the physical content credits 364 provided in association with the former digital service subscription, credit module 614 may provide a prorated percentage of the difference based on the relative remaining percentage of the initial month of the new digital service subscription.

In another implementation, subscription module 612 may receive suspension 722d(d) of the digital service subscription. For example, subscription module 612 may receive a notification of suspension 722d(d) from user device 170. Alternatively, subscription module 612 may determine that the digital service subscription is to be suspended 722d(d) based on nonpayment of a bill by the assigned billing date. Subscription module 612 may determine that the digital service subscription is to be placed on hold at the end of the calendar month 725d(d). Subscription module 612 may provide entitlement to view digital content from the digital service subscription until the end of the month to profile server 130. Credit module 614 may determine that physical content credits 364 are to be held 725d(p) at the end of the month. Credit module 614 may allow access to the physical content credits 364 until the end of the month via physical content distribution system 150.

Subscription module 612 may receive a resumption of subscription 722d(e) of the digital service subscription. Subscription module 612 may resume the digital service subscription at the beginning of the newt month. Subscription module 612 may also determine that the digital service subscription is to be prorated for the remainder of the month 725e(d) based on a date of resumption of the digital service subscription. Credit module 614 may determine that physical content credits 364 are to be prorated for the remainder of the month 725e(p). Credit module 614 may provide a prorated allocation of the physical content credits 364 based on the date of the resumption of the digital service subscription. For example, credit module 614 may approximate the proration based on an integer number of physical content credits 364 allocated monthly in association with the digital service subscription.

Activation date cycle billing and credit table 740, shown in FIG. 7C, displays subscription events 722 and corresponding activation date cycle billing and credit actions 745 that are determined based on an activation date. Subscription module 612 may determine billing actions 745(d) based on subscription events 722 and the calendar month cycle. Credit module 614 may determine credit actions 745(p) based on subscription events 722(p) and the calendar month cycle. The following implementations are described with respect billing and credit based on an activation date cycle billing cycle by subscription module 612 and credit module 614 respectively.

Subscription module 612 may receive initial subscription 722a(d) and determine that a full month is to be billed beginning at the activation date. Similarly, credit module 614 may provide an allocation of physical content credits 364 and determine that physical content credits 364 expire at the next activation date (i.e., after one activation date billing cycle). Subscription module 612 may also determine that upgrades and/or downgrades are to be limited within a period that is equivalent to a full activation date billing cycle (e.g. limit of three upgrades/downgrades for a thirty day period), and may thereby prevent abuse of physical content credits 364.

Subscription module 612 may identify that the digital service subscription is to be cancelled (cancel subscription) 722b(d) and determine that the digital service subscription is to be cancelled at the end of the activation date cycle (i.e., at the next activation date). Accordingly, subscription module 612 may provide a subscription entry 366 that includes updated entitlements (including restrictions and cancellations of entitlements) to profile server 130. Similarly, credit module 614 may receive cancel subscription 722b(p) and determine that the physical content credits 364 are to be cancelled 745b(p) at the end of the activation date cycle.

Subscription module 612 may receive an upgrade/downgrade 722c(d) of the digital service subscription. Subscription module 612 may determine that the current digital service subscription is to be cancelled at the date of the upgrade/downgrade 722c(d). Subscription module 612 may determine that the user is to be reimbursed on a prorated basis for a remainder of the activation date cycle billing cycle. Subscription module 612 may begin the new digital service subscription with a new activation date billing cycle at the upgrade/downgrade date and bill the digital user account for the new digital service subscription. Credit module 614 may cancel remaining physical content credits 364 and provide an allocation of physical content credits 364 based on the new digital service subscription.

According to another implementation, subscription module 612 may receive suspension 722d(d) of the digital service subscription. Subscription module 612 may determine that the digital service subscription is to be placed on hold at the end of the activation date cycle billing cycle 745d(d). Credit module 614 may determine that physical content credits 364 are to be held 745d(p) at the end of the activation date cycle billing cycle.

Subscription module 612 may receive a resumption of subscription 722e(d) of the digital service subscription. If the resumption 722e(d) is received within a different activation date cycle billing cycle than the suspension of subscription 722e(d), subscription module 612 may determine that a new activation date billing cycle 745e(d) at the reactivation date. However, if the resumption 722e(d) is received within the same activation date cycle billing cycle, subscription module 612 may determine that the activation date billing cycle is active and there are no changes to the digital service subscription. Credit module 614 may determine that physical content credits 364 remain the same if the resumption 722e(p) is received within the same activation date billing cycle. However, if the resumption 722e(p) is received within a different activation date billing cycle, credit module 614 may determine that physical content credits 364 are to be provided based on a full billing cycle.

Subscription module 612 may bill for the digital service subscription for each new activation date, such as an initial subscription, or the resumption of the digital service subscription. Subscription module 612 may bill for a full activation date billing cycle beginning at the new activation date. Similarly, credit module 614 may provide an allocation of the physical content credits at the new activation date for a full activation date billing cycle beginning at the new activation date.

Maximum credit counter billing and credit table 760, shown in FIG. 7D, displays subscription events 722 and maximum credit counter billing cycle billing and credit actions 765 that are determined based on a maximum credit counter. Subscription module 612 may determine billing actions 765(d) based on subscription events 722 and an assigned billing cycle, in this example, an activation date billing cycle. However, in other implementations, subscription module 612 may assign a calendar month billing cycle for the digital service subscription. Credit module 614 may determine credit actions 765(p) based on subscription events 722(p) and the maximum credit counter.

Subscription module 612 may receive initial subscription 722a(d) and determine that a billing cycle begins at the activation date 765a(d). The user account may be billed for an activation date billing cycle. Credit module 614 may set up a maximum credit counter for physical content credits 364. The maximum credit counter may include a number of physical content credits 364 for the activation date billing cycle and an offset number of physical content credits 364 that have been used by the user. The maximum credit counter may expire at the end of an assigned credit cycle that is substantially independent of the billing cycle for the digital service subscription. For example, the maximum credit counter may expire at the end of a calendar month. According to one implementation, the maximum credit counter renews (i.e., expires) after a two month period.

Subscription module 612 may identify that the digital service subscription is to be cancelled (cancel subscription) 722b(d) and determine that the digital service subscription is to be cancelled at the end of the activation date cycle. Credit module 614 may receive cancel subscription 722b(p) and determine that the maximum credit counter is to remain the same until the end of the assigned credit cycle 765b(p).

Subscription module 612 may receive an upgrade/downgrade 722c(d) of the digital service subscription. Subscription module 612 may determine that the current digital service subscription is to be cancelled at the date of the upgrade/downgrade 722c(d). Subscription module 612 may determine that the user is to be reimbursed on a prorated basis for a remainder of the activation date cycle billing cycle 765c(d). Subscription module 612 may begin the new digital service subscription with a new activation date billing cycle at the upgrade/downgrade date and bill for the new digital service subscription. Credit module 614 may change maximum credit counter to an associated maximum credit counter for the new digital service subscription 765c(p). Credit module 614 may retain a current offset for physical content credits 364 (i.e., the physical content credits 364 that the user has used may count against the maximum credit counter).

According to another implementation, subscription module 612 may receive suspension 722d(d) of the digital service subscription. Subscription module 612 may determine that the digital service subscription is to be placed on hold at the end of the activation date cycle billing cycle 765d(d). Credit module 614 may determine that the maximum credit counter is to remain the same until the end of the assigned credit cycle (e.g., the end of a calendar month in instances in which the assigned credit cycle is a calendar month cycle).

Subscription module 612 may receive a resumption of subscription 722d(e) of the digital service subscription. If the resumption 722e(d) is received within a different activation date cycle billing cycle than the suspension of subscription 722e(d), subscription module 612 may determine a new activation date billing cycle 765e(d) at the reactivation date. However, if the resumption 722e(d) is received within the same activation date cycle billing cycle, subscription module 612 may determine that the activation date billing cycle is active and there are no changes to the digital service subscription. Credit module 614 may determine that maximum credit counter remains the same until the end of the assigned credit cycle. The offset number of physical content credits 364 that have been used by the user may also remain the same.

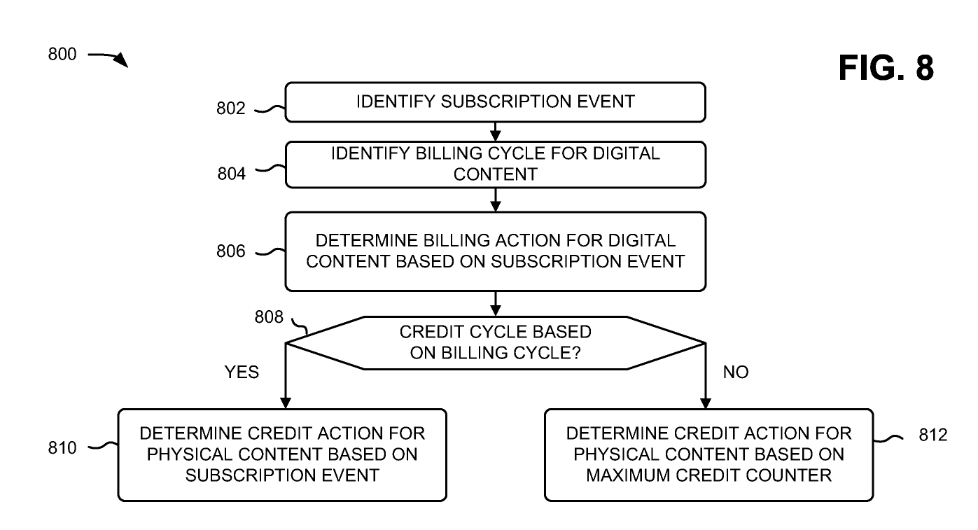

FIG. 8 is a flow chart of an exemplary process for determining cross-platform billing according to implementations described herein. Process 800 is described with respect to tables 720, 740, and 760 shown in FIGS. 7B, 7C, and 7D respectively, for illustrative purposes. In one implementation, process 800 may be performed by billing server 140. In another implementation, some or all of process 800 may be performed by another device or group of devices, including or excluding billing server 140.

As shown in FIG. 8, billing server 140 may receive a subscription event 722 (block 802). For example, billing server 140 may receive subscription event from user device 170 via data center 120. Subscription event 722 may be an initial subscription 722a(d) to digital content provided by a content provider via the cross-platform content system, i.e., a digital service subscription. The digital service subscription may include terms of service, entitlements, billing dates, etc. for the digital content. In another example, subscription event 722 may be a modification to an existing digital service subscription, such as a cancellation 722b(d), an upgrade/downgrade 722c(d), a suspension 722d(d), or resumption of subscription 722e(d) of the digital service subscription.

At block 804, billing server 140 may identify a billing cycle associated with the digital content. For example, as described with respect to FIG. 7B hereinabove, billing server 140 may identify the associated billing cycle for the digital service subscription as a calendar month billing cycle. Alternatively, as described with respect to FIG. 7C hereinabove, billing server 140 may identify the associated billing cycle as an activation date billing cycle.

Billing server 140 may determine a billing action for the digital content based on subscription event 722 and the identified billing cycle (block 806). Billing server 140 may determine a billing action for the digital content based on the calendar month cycle, such as shown in table 720 described with respect to FIG. 7B.

At block 808, billing server 140 may determine whether the physical content credits 364 are to be provided using an associated credit cycle based on the identified billing cycle for the digital content.

Billing server 140 may determine a credit action for the physical content based on the identified subscription event and the associated credit cycle in response to a determination, at block 808, that the associated credit cycle is based on the identified billing cycle (block 810). For example, if the identified billing cycle for the digital content is a calendar month billing cycle, billing server 140 may determine the associated credit cycle for the digital service subscription as a calendar month cycle. For example, if a user suspends 722d(d) a digital service subscription for a calendar month billing cycle, billing server 140 may determine that the digital service subscription is to be held 725d(d) at the end of the month.

Billing server 140 may determine a credit action for the physical content based on subscription event 722 and a maximum credit counter in response to a determination, at block 808, that the associated credit cycle is not based on the identified billing cycle (block 812). Billing server 140 may determine billing action for the digital content similarly as described at block 808.

According to one implementation, billing server 140 may establish a maximum credit counter in response to an initial subscription 722a(d). Billing server 140 may use an offset for the maximum credit counter that increases for each physical content credit 364 used by the user until the allocation of physical content credits 364 provided, for example in association with the digital service subscription, have been used up within a credit cycle for the maximum credit counter.

FIG. 9 is a flow chart of an exemplary process for determining billing options in a cross-platform content system according to implementations described herein. In one implementation, process 900 may be performed by billing server 140. In another implementation, some or all of process 900 may be performed by another device or group of devices, including or excluding billing server 140.

As shown in FIG. 9, billing server 140 receive a subscription event (block 902). For example, billing server 140 may receive a subscription event from a user via a web interface, such as when the user subscribes to digital content via a web based application. Billing server 140 may identify a user entity associated with the subscription event (block 904). The user entity may include a user profile or a user device.

At block 906, billing server 140 may determine whether an associated service provider has a billing account associated with the user entity. For example, billing server 140 may provide information to profile server 130, which may search stored user profile information for a plurality of users to determine whether there is an existing billing account associated with the user entity.

At block 908, in response to a determination that the service provider has an existing billing account associated with the user entity, billing server 140 may provide an option to pay for the subscription event using the billing account associated with the user.

At block 910, in response to a determination that the service provider does not have an existing billing account associated with the user entity, billing server 140 may send a request for billing information to the user entity. The user may complete the transaction by providing billing information, such as credit card numbers, bank account numbers, etc., in response to the request for billing information.

Systems and/or methods described herein may allow user devices to provide billing for digital content and associated credit for physical content in a cross-platform content system. The billing and credit for the content may be provided based on a billing cycle, such as a calendar month cycle or an activation date cycle. Alternatively, credit may be provided based on a maximum counter that is substantially independent of the identified billing cycle.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIG. 8 and FIG. 9, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A computer-implemented method comprising:
identifying a subscription event for a digital service subscription for digital content;
identifying a billing cycle for the digital content;
determining a billing action for the digital content based on the subscription event and the identified billing cycle;
determining whether an associated credit cycle for physical content is based on the identified billing cycle;
determining a credit action for physical content credits based on the subscription event and the credit cycle in response to a determination that the credit cycle is based on the identified billing cycle; and
determining a credit action for the physical content credits based on the subscription event and a maximum credit counter in response to a determination that the credit cycle is not based on the identified billing cycle.

2. The computer-implemented method of claim 1, wherein the subscription event is a cancellation of the digital service subscription, and wherein determining the billing action and the credit action further comprises:
cancelling billing for the digital service subscription at the end of the identified billing cycle; and
cancelling the provision of the physical content credits at the end of the credit cycle.

3. The computer-implemented method of claim 1, wherein the subscription event is a suspension of the digital service subscription, and wherein determining the billing action and the credit action further comprises:
holding the digital service subscription at the end of the identified billing cycle; and
holding provision of the physical content credits at the end of the identified billing cycle.

4. The computer-implemented method of claim 1, wherein, when the identified billing cycle is a calendar month billing cycle, further comprising:
billing a user account for the digital service subscription at a recurring date provided by a content provider in each calendar month.

5. The computer-implemented method of claim 4, wherein, when the identified subscription event is an initial subscription to the digital service subscription, and wherein determining the billing action and the credit action further comprises:
billing for a first month of the digital service subscription at a prorated rate based on a date of the initial subscription and the calendar month billing cycle; and
providing a prorated allocation of the physical content credits based on the date of the initial subscription and the calendar month billing cycle.

6. The computer-implemented method of claim 4, wherein, when the identified subscription event is one of an upgrade or a downgrade of the digital service subscription, and wherein determining the billing action and the credit action further comprises:
cancelling the digital service subscription;
providing a prorated reimbursement for a remainder of the calendar month based on a date of the upgrade or the downgrade;
billing for a first month of a new digital service subscription at a prorated rate based on the date of the upgrade or the downgrade; and
providing a prorated allocation of the physical content credits based on the date of the upgrade or the downgrade.

7. The computer-implemented method of claim 4, wherein, when the identified subscription event is a resumption of the digital service subscription, and wherein determining the billing action and the credit action further comprises:
billing for a first month of resumed service of the digital service subscription at a prorated rate based on a date of resumption of the digital service subscription; and
providing a prorated allocation of the physical content credits based on the date of the resumption of the digital service subscription.

8. The computer-implemented method of claim 1, wherein, when the identified billing cycle is an activation date billing cycle, further comprising:
billing a user account for the digital service subscription at an activation date for the digital service subscription associated with the user.

9. The computer-implemented method of claim 8, wherein, when the identified subscription event is one of an initial subscription, or a resumption of the digital service subscription, and wherein determining the billing action and the credit action further comprises:
billing for the one of the initial subscription, or the resumption of the digital service subscription for a full activation date billing cycle beginning at the date of the one of the initial subscription, or the resumption of the digital service subscription; and
providing an allocation of the physical content credits at the one of the initial subscription, or the resumption of the digital service subscription for a full activation date billing cycle beginning at the date of the one of the initial subscription, or the resumption of the digital service subscription.

10. The computer-implemented method of claim 8, wherein the identified subscription event is one of an upgrade or a downgrade of the digital service subscription, and wherein determining the billing action and the credit action further comprises:
cancelling the digital service subscription;
providing a prorated reimbursement for a remainder of the identified billing cycle based on a date of the upgrade or the downgrade;
billing a new digital service subscription at the date of the upgrade or the downgrade for a new activation date billing cycle;
voiding the physical content credits associated with the digital service subscription; and
issuing physical content credits associated with the new digital service subscription.

11. The computer-implemented method of claim 1, wherein determining the credit action for the physical content credits based on the identified subscription event and the maximum credit counter further comprises:
providing a maximum credit count for the physical content credits, wherein physical content credits are issued at a date associated with the maximum credit count;
providing an offset for the physical content credits based on the physical content credits used in association with a user account; and
determining the maximum credit count and the offset for the physical content credits based on the identified subscription event.

12. The computer-implemented method of claim 1, further comprising:
determining a subscriber status associated with a subscriber to the digital service subscription based on a length of time that the subscriber has received the digital service subscription; and
determining a credit type for the physical content credit based on the subscriber status and the billing cycle, wherein the credit type is one or more of digital video disc (DVD) credits and Blu-ray credits.

13. The computer-implemented method of claim 1, further comprising:
identifying a user entity associated with the subscription event, wherein the user entity includes one or more of a user profile and a user device;
determining whether a billing account associated with the user entity is provided by an associated service provider; and
providing an option to pay for the subscription event using the billing account associated with the user entity in response to a determination that the billing account associated with the user entity is provided by an associated service provider.

14. A device, comprising:
a memory to store a plurality of instructions; and
a processor configured to execute instructions in the memory to:
identify a subscription event for digital content;
identify a billing cycle for the digital content;
determine whether an associated credit cycle for physical content is based on the identified billing cycle;
determine a billing action for the digital content based on the identified subscription event and the identified billing cycle;
determine a credit action for the physical content based on the identified subscription event and the credit cycle in response to a determination that the associated credit cycle is based on the identified billing cycle; and
determine a credit action for the physical content based on the identified subscription event and a maximum credit counter in response to a determination that the associated credit cycle is based on the identified billing cycle.

15. The device of claim 14, wherein the identified subscription event is a cancellation of the digital service subscription, and wherein, when determining the billing action and the credit action, the processor is further configured to:
end billing for the digital service subscription at the end of the identified billing cycle; and
end the provision of the physical content credits at the end of the associated credit cycle.

16. The device of claim 14, wherein the identified subscription event is a suspension of the digital service subscription and wherein, when determining the billing action and the credit action, the processor is further configured to:
hold the digital service subscription at the end of the identified billing cycle; and
hold provision of the physical content credits at the end of the identified billing cycle.

17. The device of claim 14, wherein the identified billing cycle is a calendar month billing cycle, and the processor is further configured to:
bill a user account for the digital service subscription at a recurring date provided by a content provider in each calendar month.

18. The device of claim 14, wherein the identified billing cycle is an activation date billing cycle, and the processor is further configured to:
bill a user account for the digital service subscription at an activation date for the digital service subscription associated with the user.

19. The device of claim 14, wherein, when determining the credit action for the physical content credits based on the identified subscription event and the maximum credit counter, the processor is further configured to:
provide a maximum credit count for the physical content credits, wherein physical content credits are issued at a date associated with the maximum credit count;
provide an offset for the physical content credits based on the physical content credits used in association with a user account; and
determine the maximum credit count and the offset for the physical content credits based on the identified subscription event.

20. The device of claim 14, wherein the processor is further configured to:
determine a subscriber status associated with a user account for a subscriber to the digital service subscription, wherein the subscriber status is based on a length of time that the subscriber has received the digital service subscription;
identify a default credit type for physical content credit based on the subscriber status and the billing cycle; and
determine a credit type for the physical content credit based on the subscriber status and the billing cycle, wherein the credit type is one or more of digital video disc (DVD) credits and Blu-ray credits.

21. The device of claim 14, wherein the processor is further configured to:
identifying a user entity associated with the subscription event, wherein the user entity includes one or more of a user profile and a user device;
determine whether a billing account associated with the user entity is provided by an associated service provider; and
provide an option to pay for the subscription event using the billing account associated with the user entity in response to a determination that the billing account associated with the user entity is provided by an associated service provider.

22. A computer-readable medium including instructions to be executed by a processor, the instructions including one or more instructions, when executed by the processor, for causing the processor to:
identify a subscription event for digital content;
identify a billing cycle for the digital content;
identify an associated credit cycle for physical content;
determine a billing action for the digital content based on the identified subscription event and the identified billing cycle;
determine a credit action for the physical content based on the identified subscription event and the associated credit cycle in response to a determination that the associated credit cycle is based on the identified billing cycle, wherein the credit action is one of an initial subscription, a cancellation, an upgrade, a downgrade, a suspension, and a resumption of the digital service subscription.

23. The computer-readable medium of claim 22, wherein the associated credit cycle comprises an activation date billing cycle, and the one or more instructions further includes instructions to:
bill a user account for the digital service subscription at a recurring date provided by a content provider in each calendar month.

24. The computer-readable medium of claim 22, wherein the identified billing cycle is an activation date billing cycle, and wherein the one or more instructions further includes instructions to:
bill a user account for the digital service subscription at an activation date for the digital service subscription associated with the user.

25. The computer-readable medium of claim 22, wherein the one or more instructions further includes instructions to:
determining the credit action for the physical content credits based on the identified subscription event and the maximum credit counter in response to a determination that the associated credit cycle is not based on the identified billing cycle, wherein the maximum credit counter includes a maximum credit count for the physical content credits, wherein physical content credits are issued at a date associated with the maximum credit count, and an offset for the physical content credits based on the physical content credits used in association with a user account.
